(19) United States
(12) Patent Application Publication
(10) Pub. No.: US 2026/0037631 A1
(43) Pub. Date: Feb. 5, 2026

(54) GUARDING MODULE LOADING FOR CYBERSECURITY

(71) Applicant: Binary Defense Systems, Inc., Stow, OH (US)

(72) Inventor: Alex Ball, Wichita, KS (US)

(21) Appl. No.: 19/287,235

(22) Filed: Jul. 31, 2025

Related U.S. Application Data
(60) Provisional application No. 63/677,786, filed on Jul. 31, 2024.

(51) Int. Cl. G06F 21/56; G06F 21/62

(52) U.S. Cl. CPC G06F 21/566; G06F 21/62; G06F 2221/034

(57) ABSTRACT

A memory block storing a valid memory address of a protected loader block is modified to store an invalid memory address. Responsive to a determination that an invalid memory access exception was caused by an attempt to access an invalid memory address of a protected loader block, an exception handler determines whether the attempt to access the protected loader block should be authorized. If authorized, the exception handler patches a memory block storing the invalid memory address of the protected loader block, within the thread context of the invalid memory access exception, with a valid memory address. After the authorized attempt to access the protected loader block has been completed, the exception handler unpatches the memory block previously patched with the valid memory address of the protected loader block to store an invalid memory address again. If accessing the protected loader block is not authorized, mitigation is performed.

### CROSS-REFERENCE TO RELATED APPLICATION

This application claims the priority benefit of U.S. provisional patent application Ser. No. 63/677,786 entitled “GUARDING MODULE LOADING FOR CYBERSECURITY” and filed on Jul. 31, 2024, the disclosure of which is incorporated herein in full.

### TECHNICAL FIELD

The present disclosure generally relates to cybersecurity, and more specifically relates to guarding module loading for cybersecurity.

### BACKGROUND

Since at least the advent of the World Wide Web, there have been malicious attempts to hack into or otherwise do harm to websites, servers, and computers on the Internet. Indeed, even prior to the advent of the World Wide Web, computer viruses and other malware have been developed and distributed in an attempt to hack into or otherwise do harm to computer systems, referred to herein as endpoints. Various attempts have been made to detect and prevent such malicious attempts from succeeding, including anti-virus software, malware removal tools, and the like.

The description provided in the background section should not be assumed to be prior art merely because it is mentioned in or associated with the background section. The background section may include information that describes one or more aspects of the subject technology.

### SUMMARY

An exemplary non-transitory computer readable medium stores computer-readable instructions executable by a hardware computing processor to perform operations of a method for guarding module loading for cybersecurity as described herein.

An exemplary system for guarding module loading for cybersecurity includes at least one device including a hardware computing processor, the system being configured to perform operations of a method for guarding module loading for cybersecurity as described herein. The system may include a non-transitory memory having stored thereon computing instructions, executable by the hardware computing processor, to perform operations of a method for guarding module loading for cybersecurity as described herein.

An exemplary system for guarding module loading for cybersecurity includes at least one device including a hardware circuit operable to perform a function, the system being configured to perform operations of a method for guarding module loading for cybersecurity as described herein.

One or more exemplary non-transitory machine-readable media store instructions which, when executed by one or more processors, cause operations to be performed establishing an exception handler configured to be called responsive to the one or more processors detecting an invalid memory access exception. The exception handler is configured to determine whether the invalid memory access exception was caused by an attempt to access an invalid memory address of a protected loader block to access the protected loader block. The exception handler is also configured to, responsive to a determination that the invalid memory access exception was caused by an attempt to access an invalid memory address of a protected loader block, determine whether the attempt to access the protected loader block should be authorized. The exception handler is also configured to, responsive to a determination that the attempt to access the protected loader block should be authorized, patch a memory block storing the invalid memory address of the protected loader block with a valid memory address of the protected loader block. The exception handler is also configured to determine whether the authorized attempt to access the protected loader block has been completed, and responsive to a determination that the authorized attempt to access the protected loader block has been completed, unpatch the memory block previously patched with the valid memory address of the protected loader block to store the invalid memory address again. The exception handler is also configured to, responsive to a determination that the attempt to access the protected loader block should not be authorized, notify a process for performing mitigation of the unauthorized attempt to access the protected loader block. After the exception handler is configured and established, the instructions cause operations to be performed to modify the memory block storing the valid memory address of the protected loader block to store the invalid memory address. The processes of the exception handler are performed responsive to a call, received by the exception handler, that is responsive to an invalid memory access exception.

The memory block storing the valid memory address of the protected loader block may be disposed within a region of memory that is associated with a particular process environment block associated with the attempt to access the protected loader block.

The particular process environment block may be associated with a thread environment block associated with the attempt to access the protected loader block.

Patching the memory block storing the invalid memory address of the protected loader block with the valid memory address of the protected loader block may be performed within a thread context associated with the thread environment block and with the attempt to access the protected loader block.

Patching the memory block storing the invalid memory address of the protected loader block with the valid memory address of the protected loader block may include editing the thread context to update a register referencing the invalid memory address with the valid memory address of the protected loader block.

The media may further store instructions which, when executed by one or more processors, cause logging one or more events and/or raising one or more alerts responsive to the determination that the attempt to access the protected loader block should not be authorized.

The determination that the attempt to access the protected loader block should be authorized may be made responsive to a determination that the attempt is being made by operating system code.

The determination that the attempt to access the protected loader block should be authorized may be made responsive to a determination that the attempt is being made by an authorized program code.

The determination that the attempt to access the protected loader block should be authorized may be made responsive to a determination that the attempt is being made by a mapped module.

The determination that the attempt to access the protected loader block should be authorized may be made responsive to a predetermined cybersecurity policy.

The determination that the attempt to access the protected loader block should be authorized may be made based on an analysis of contents of code attempting to access the protected loader block.

An exemplary system for guarding module loading for cybersecurity of a computing system includes a hardware computing processor, and a non-transitory memory having stored thereon computing instructions, executable by the hardware computing processor, to perform operations of a method for guarding module loading for cybersecurity of a computing system. The method includes establishing an exception handler configured to handle an invalid memory access exception, modifying a memory block storing a valid memory address of a protected loader block to store an invalid memory address, and receiving, by the exception handler, a call responsive to the invalid memory access exception. The method also includes, responsive to the received call by the exception handler, determining whether the invalid memory access exception was caused by an attempt to access an invalid memory address of a protected loader block to access the protected loader block. The method also includes, responsive to a determination that the invalid memory access exception was caused by an attempt to access an invalid memory address of a protected loader block, determining whether the attempt to access the protected loader block should be authorized. The method also includes, responsive to a determination that the attempt to access the protected loader block should be authorized, patching a memory block storing the invalid memory address of the protected loader block with a valid memory address of the protected loader block. The method also includes, responsive to a determination that the authorized attempt to access the protected loader block has been completed, unpatching the memory block previously patched with the valid memory address of the protected loader block to store the invalid memory address again. The method also includes, responsive to a determination that the attempt to access the protected loader block should not be authorized, notifying a process for performing mitigation of the unauthorized attempt to access the protected loader block.

The memory block storing the valid memory address of the protected loader block may be disposed within a region of memory that is associated with a particular process environment block associated with the attempt to access the protected loader block.

The particular process environment block may be associated with a thread environment block associated with the attempt to access the protected loader block.

Patching the memory block storing the invalid memory address of the protected loader block with the valid memory address of the protected loader block may be performed within a thread context associated with the thread environment block and with the attempt to access the protected loader block.

Patching the memory block storing the invalid memory address of the protected loader block with the valid memory address of the protected loader block may include editing the thread context to update a register referencing the invalid memory address with the valid memory address of the protected loader block.

The non-transitory memory may further store instructions which, when executed by the processor, cause logging one or more events and/or raising one or more alerts responsive to the determination that the attempt to access the protected loader block should not be authorized.

The determination that the attempt to access the protected loader block should be authorized may be made responsive to a determination that the attempt is being made by operating system code.

The determination that the attempt to access the protected loader block should be authorized may be made responsive to a determination that the attempt is being made by an authorized program code.

An exemplary method includes establishing an exception handler configured to handle an invalid memory access exception, modifying a memory block storing a valid memory address of a protected loader block to store an invalid memory address, and receiving, by the exception handler, a call responsive to the invalid memory access exception. The method also includes, responsive to the received call by the exception handler, determining whether the invalid memory access exception was caused by an attempt to access an invalid memory address of a protected loader block to access the protected loader block. The method also includes, responsive to a determination that the invalid memory access exception was caused by an attempt to access an invalid memory address of a protected loader block, determining whether the attempt to access the protected loader block should be authorized. The method also includes, responsive to a determination that the attempt to access the protected loader block should be authorized, patching a memory block storing the invalid memory address of the protected loader block with a valid memory address of the protected loader block. The patched memory block is disposed within a region of memory associated with a particular process environment block associated with the attempt to access the protected loader block. The particular process environment block is associated with a thread environment block that is also associated with the attempt to access the protected loader block. The patching is performed within a thread context associated with the thread environment block and with the attempt to access the protected loader block. The patching includes editing the thread context to update a register referencing the invalid memory address with the valid memory address of the protected loader block. The method also includes, responsive to a determination that the authorized attempt to access the protected loader block has been completed, unpatching the memory block previously patched with the valid memory address of the protected loader block to store the invalid memory address again. The method also includes, responsive to a determination that the attempt to access the protected loader block should not be authorized, notifying a process for performing mitigation of the unauthorized attempt to access the protected loader block.

An exemplary method for guarding module loading for cybersecurity of a computing system includes establishing an exception handler to handle memory access violations, overwriting a memory address of a loader, and determining if a memory access violation to the overwritten memory address is from authorized code. The method also includes, responsive to a determination that the memory access violation to the overwritten memory address is from authorized code, patching an invalid memory address associated with the memory access violation within a thread context with a correct memory address, and unpatching the patched invalid memory address associated with the memory access violation.

The method may further include, responsive to a determination that the memory access violation to the overwritten memory address is not from authorized code, notifying a managed endpoint detection and response (MEDR) system of the memory access violation, and triggering mitigation. The thread context may include the thread context of the memory access violation.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 is a flow chart that illustrates operation of an exemplary managed endpoint detection and response (MEDR) system.

FIG. 2 is a system diagram that illustrates an exemplary managed endpoint detection and response (MEDR) system.

FIG. 3 is a flow chart that illustrates an exemplary process of disrupting unauthorized code executing on a computing processor.

FIG. 4 is a system diagram that illustrates an exemplary computing system on which code executing accesses pointers to memory addresses associated with executable process modules.

FIG. 5 is a system diagram that illustrates an exemplary computing system on which the MEDR system described herein disrupts unauthorized code executing on the computing system.

FIG. 6 illustrates an exemplary method of guarding executable code's access to the loader block associated with a process environment block.

FIG. 7 illustrates an exemplary method of guarding executable code's access to the loader block associated with a process environment block.

FIG. 8 depicts a block diagram of an example computer system in which examples described herein may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides a managed endpoint detection and response (MEDR) system as a computer-based cybersecurity system that may manage the security of numerous endpoint computer systems against malicious attacks (e.g., from hackers, viruses, malware, etc.) from a central managing computer system. The MEDR system may monitor and analyze computing and/or communication events to detect unusual or atypical behavioral patterns that may indicate or correlate with one or more cybersecurity threats. The MEDR system may initiate active computing and/or communications events that target detected bad actors by deceiving the bad actors to disrupt the detected active cybersecurity threats. The MEDR system may layer one or more types of deception targeting the bad actors in each of numerous phases of a detected cyberattack to confuse the bad actors in the cyberattack and avoid the bad actors from detecting the actions of the MEDR system in defending against the cyberattack.

The MEDR system may utilize artificial intelligence algorithms, including machine learning algorithms, to identify one or more indicators of a compromise of computer system security caused by a cybersecurity attack. The MEDR system's machine learning algorithms may detect anomalies and potential cybersecurity threats, for example, based on a training of the machine learning algorithms on known threats and their characteristics. The MEDR system may analyze software code and programming languages in a computing system environment utilizing generative artificial intelligence algorithms (e.g., Large Language Models) to determine a confidence scoring for detecting malicious code execution in the computing system, or for detecting suspicious indicators of a cybersecurity compromise in the computing system.

The MEDR may determine which portion(s) of the computing system have been compromised by the cyberattack, for example, which login accounts in a multi-user computing system, such that the response may include disabling the compromised portion(s) or login accounts.

For example, cybersecurity threats include a class of attacks on computer systems that facilitate unauthorized code to be executed on a computing processor of the attacked computer system. The unauthorized code may have a behavioral pattern, e.g., a typical sequence of operations or events that the unauthorized code causes on the attacked computer system, that may be recognizable as characteristic of the class of attacks with which the unauthorized code is related. Examples of the MEDR disclosed herein may recognize the characteristics of the class of attacks with which the unauthorized code is related, and disrupt the workflow of the unauthorized code to prevent initialization of the unauthorized code on the attacked computer system.

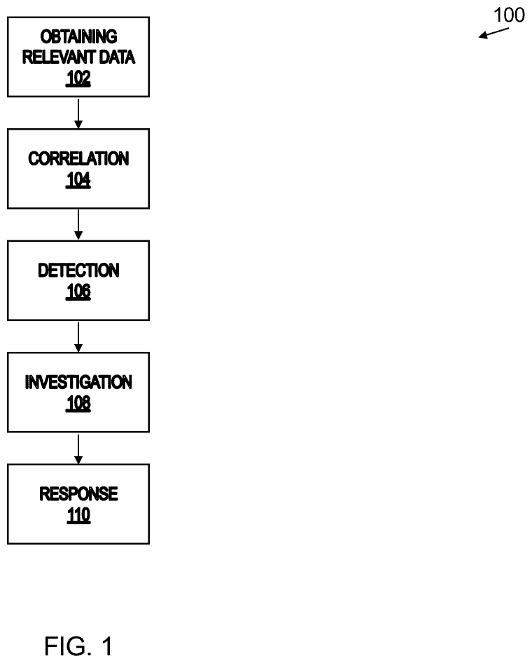

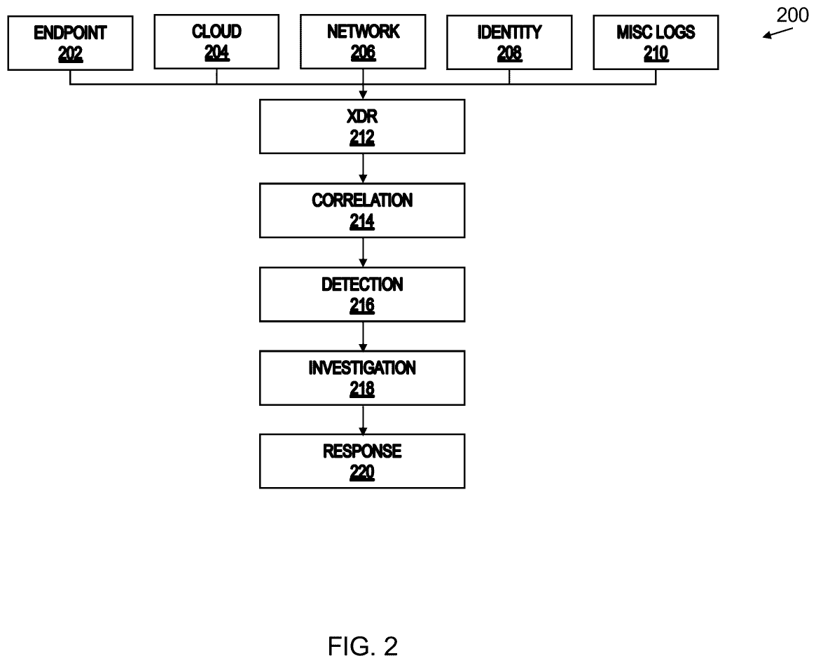

FIG. 1 is a flow chart that illustrates operation of an exemplary managed endpoint detection and response (MEDR) system. FIG. 2 is a system diagram that illustrates an exemplary managed endpoint detection and response (MEDR) system. The MEDR system may include modules that store and utilize cybersecurity threat data and cybersecurity threat research, emulate cybersecurity threats, hunt for cybersecurity threats within data and computing system behaviors, and hunt for cybersecurity threats via data and behavioral analysis.

In an obtaining relevant data process 102, an extended detection and response (XDR) module may input data from multiple relevant data sources, for example, one or more endpoints 202, data sources in a cloud 104 (e.g., accessible over a large computing network, e.g., the Internet), data sources on one or more local or known networks 106, data sources associated with identity 108 (e.g., user identity), and/or various computing logs 110. The relevant data sources may include data sources that provide information relevant to cybersecurity, for example, various cybersecurity tools and modules capable of detecting and/or providing information related to cybersecurity threats. The XDR module may include or interface with one or more submodules for assessing cybersecurity of the computing system environment of the MEDR system. In various examples, the XDR module 212 may include computer-executable instructions configured to execute on a computing processor, for example, a computer processor of one or more endpoints 202.

In a correlation process 104, a correlation module 214 may combine the data from the multiple relevant data sources with data specific to the computing environment of the MEDR system. The correlation process 104 may generate high fidelity signature and behavior-based detections of cybersecurity threats.

In a detection process 106, a detection module 216 may issue alerts based on cybersecurity threats detected via the correlation process 104. In an investigation process 108, an investigation module 218 may remove potential false positives received from the detection module 216 and perform further investigations into detected cybersecurity threats which are determined to require further investigation.

In a response process 110, a response module 220 may execute one or more response strategies based on the detected cybersecurity threats. The response strategies may include notifications to designated notification contacts, disabling computer communications outside the local computing system, storing a current snapshot backup of the computing system state and data onto a nonvolatile memory, and/or restoring the computing system state and data to a previously stored snapshot backup of the computing system state and data, for example.

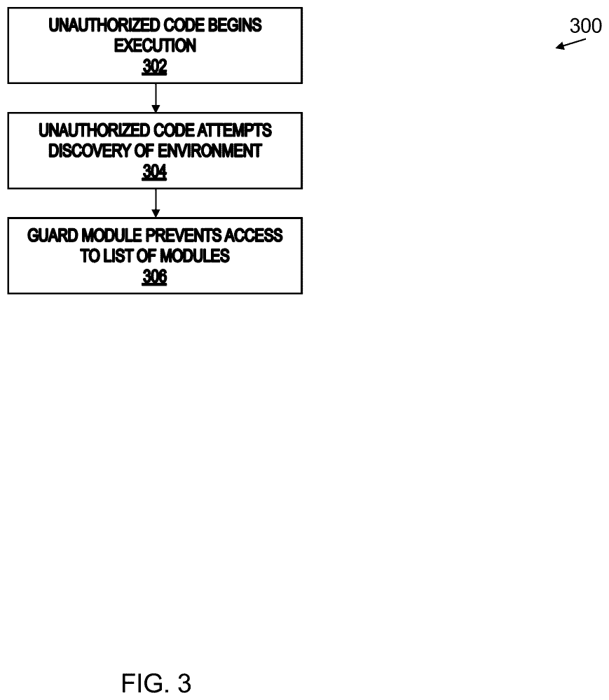

FIG. 3 is a flow chart that illustrates an exemplary process of disrupting unauthorized code executing on a computing processor. In an operation 302, unauthorized code may begin executing on the computing processor. The unauthorized code may include a shellcode program. The unauthorized code may have originated from a compromised computer file, for example, on the network 206, the cloud 204 (e.g., the Internet or a web site), or an external data storage device communicatively connected to the endpoint 202. The compromised computer file may have a malformation that may cause the unauthorized code to execute on the computing processor. The compromised computer file may, for example, cause a buffer overrun or be of a similar cybersecurity class of attack.

In an operation 304, the unauthorized code may attempt to discover the environment in which the unauthorized code is executing, including communications capabilities for the unauthorized code to communicate beyond the local computer system on which the unauthorized code is executing, for example, with other computer and communication systems on in the cloud 204. As part of this discovery operation 304, the unauthorized code may attempt to discover a location of a list of executable modules present on the computer system on which the unauthorized code is executing. If successful in discovering a location of the list of executable modules, the unauthorized code may then attempt to discover locations of the executable modules themselves. If successful in accessing the locations of executable modules, the unauthorized code may then attempt to locate specific functions within those modules which the unauthorized code may attempt to execute.

In an operation 306, a guard module of the MEDR system may prevent the unauthorized code from discovering the location of the list of modules. Thus, the guard module of the MEDR system may guard the list of modules itself from the unauthorized code. In contrast to prior MEDR systems, examples of the MEDR system described herein may prevent access by the unauthorized code to the location of the list of modules. Therefore, examples of the MEDR system described herein may interfere with the unauthorized code's access to functions of other modules on the attacked computer system earlier in the unauthorized code's attack process.

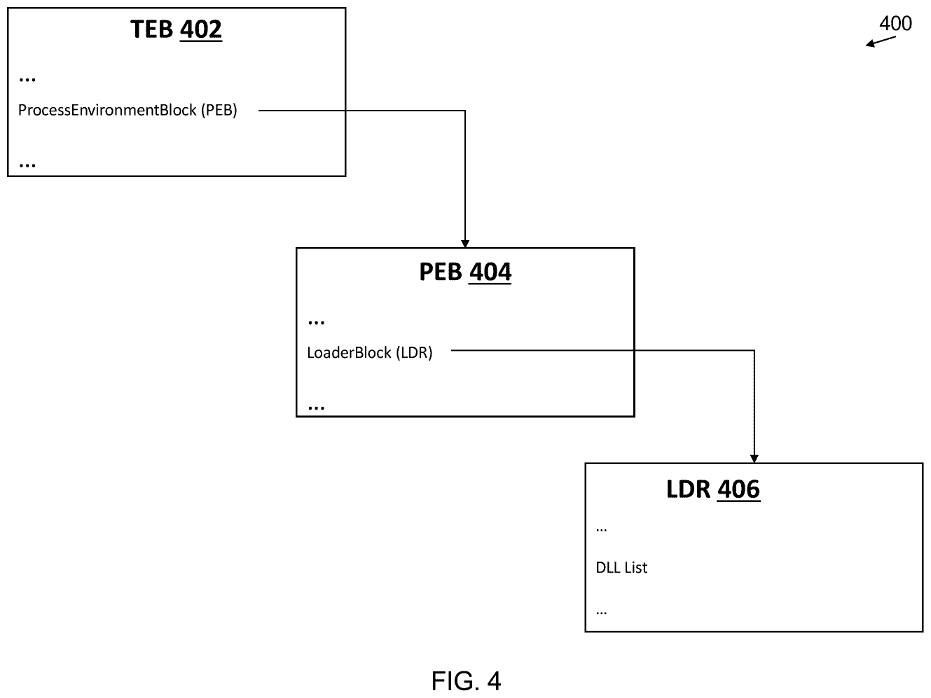

FIG. 4 is a system diagram that illustrates an exemplary computing system on which code executing accesses pointers to memory addresses associated with executable process modules. A thread environment block (TEB) 402 may include a pointer to a process environment block (PEB) 404, which may include a region of memory in a computing system that is associated with a particular process executing on a computing processor of the computing system. The PEB 404 may include a pointer to a loader block (LDR) 406. The LDR 406 may include information about the executing process associated with the PEB 404, including a pointer to a list of running modules in the executing process associated with the PEB 404. Ordinarily, when a shellcode program executes, the shellcode program locates the PEB 404, then uses the PEB 404 to find the LDR 406, and then uses the LDR 406 to find the list of running modules. This is because a shellcode program may not inherently have information regarding where any modules of the computing system on which the shellcode program executes are located within the computing system's memory. The shellcode program may ordinarily communicate with the computing system on which the shellcode program is executing in order to discover the memory addresses of operating system (OS) libraries, system calls, various executable modules, etc.

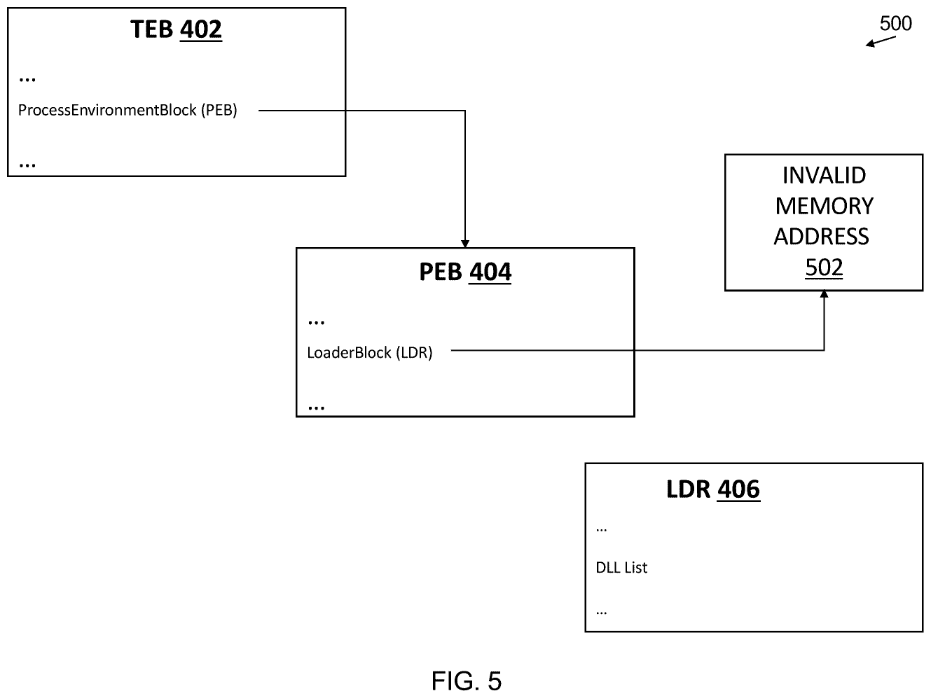

FIG. 5 is a system diagram that illustrates an exemplary computing system on which the MEDR system described herein disrupts unauthorized code executing on the computing system. In contrast to normal operations of the computing system and shellcode programs executing thereon as illustrated and described above with respect to FIG. 4, examples of the MEDR system described herein may guard the list of running modules to prevent unauthorized shellcode programs from finding their memory addresses. To guard the list of running modules, examples of the MEDR system described herein may block the LDR 406 from the executing shellcode program by changing the pointer to the LDR 406 in the PEB 404, for example, by writing an invalid memory address 502 in place of the actual memory address of the LDR 406. The invalid memory address 502 written may be to a region of memory known to be invalid. In an example, a memory register being dereferenced to access the protected memory of the LDR 406 may be modified. Thus, any code's attempt (including the unauthorized code's attempt) to access the LDR 406 may fail, unless additional operations are undertaken to facilitate authorized access.

To facilitate authorized code to be able to access the LDR 406, the MEDR system described herein may monitor access to the LDR 406 by installing an exception handler to facilitate access to the LDR 406 when an authorized code attempts to access the LDR 406, and only block access to the LDR 406 when an unauthorized code attempts to access the LDR 406. For example, when an access attempt to the LDR 406 is made, the MEDR system described herein may check to determine whether the code attempting to access the LDR 406 should be able to do so. If a determination is made that the code attempting to access the LDR 406 should be able to do so (e.g., the code attempting the access is an operating system code or other authorized code), the MEDR system described herein may patch the fake memory address previously stored in the PEB 404 in place of the pointer to the LDR 406, with the correct memory address. Therefore, the authorized code may be able to use the correct memory address in the PEB 404's link to the LDR 406 to access the LDR 406. This may result in a fail-closed approach where the default action is to block, so that shellcode trying to bypass the mitigation employed by the systems and methods described herein may result in an invalid memory access. Thus, any shellcode attempting to circumvent the mitigation may still result in a memory access violation. Alternative prior approaches to mitigation, for example, guard pages, may be more easily circumvented than the systems and methods described herein.

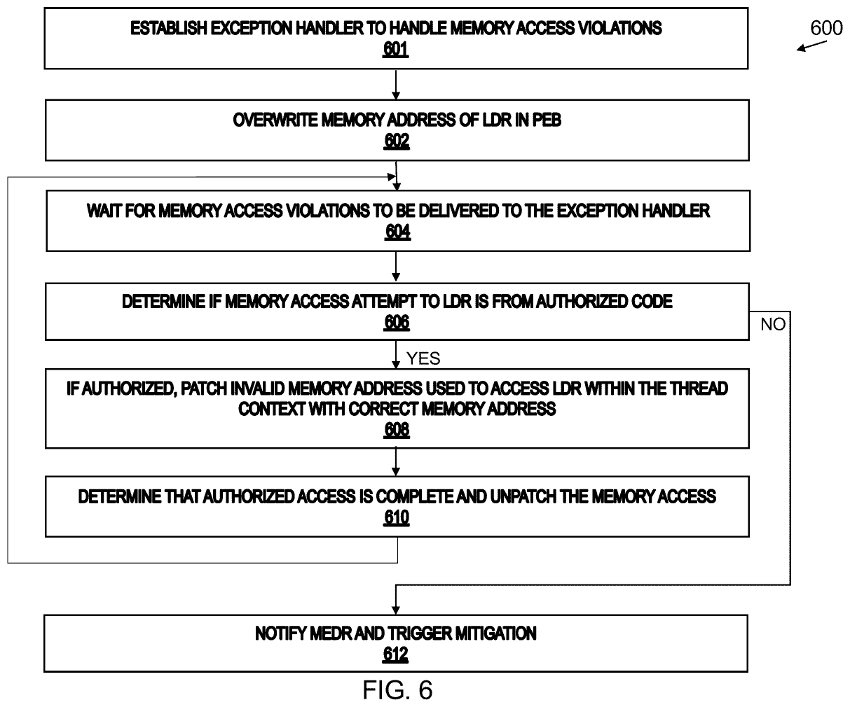

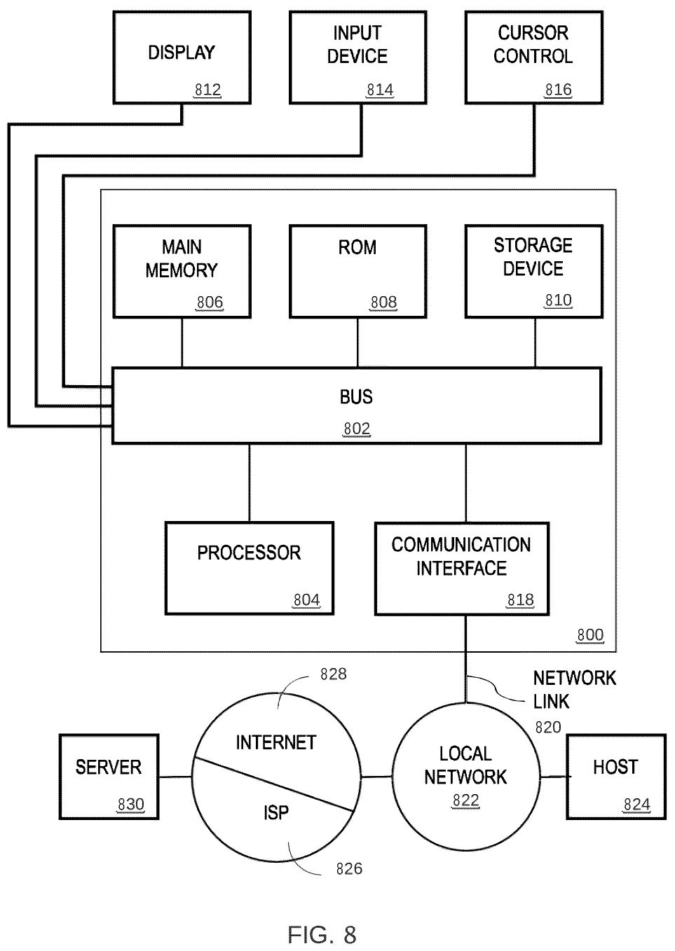

FIG. 6 illustrates an exemplary method 600 of guarding executable code's access to a loader block 406 associated with a process environment block 404. The exemplary method 600 may be performed by one or more hardware computing processors, for example, as illustrated and described herein with reference to FIG. 8.

In an operation 601, an exception handler may be configured and established to handle memory access violations. Memory access violations may include or be designated as/with invalid memory access exceptions. With an exception handler in place to handle the memory access violations, monitoring memory access attempts may be performed passively without consuming central processor unit (CPU) utilization. For example, an operating system of the computing system may notify the MEDR system when an invalid memory access occurs. In prior systems, in the absence of the use of an exception handler to handle memory access violations, monitoring memory access may include utilizing guard pages, which may be unsuccessful. In contrast, utilizing an exception handler to handle memory access violations as discussed herein, a thread context may be used to patch the memory access.

In an operation 602, a LDR Guard Module may modify the memory address of the LDR 406 stored in the PEB 404 to point to an invalid memory address 502. In an example, program code (unauthorized or authorized) may dereference this pointer to access the protected memory of the LDR 406, either for read or write access. Operation 602 may only be performed once, and not repeatedly, in the method 600, due to the transient nature of the thread context of the method 600 described herein.

In an operation 604, the MEDR system may wait for memory access violations to be delivered to the exception handler. In an example, memory access attempts to the invalid memory address that replaced the reference to LDR 406 may be monitored by an exception handler that responds to exception code 0xC0000005 (EXCEPTION_ACCESS_VIOLATION).

In an operation 606, the exception handler may check whether the access violation was caused by an attempt to access the LDR 406, and a determination may be made regarding whether the code attempting to access the LDR 406 is authorized to do so (e.g., the code attempting the access is an operating system code or other authorized code), and should be able to do so. Access may be allowed, for example, when the code attempting access is operating system code (e.g., a system DLL, NTDLL, etc.). In some examples, access may be allowed for any mapped module. In some examples, access allowance may be determined according to a predetermined cybersecurity policy. In some examples, access may be allowed based on an analysis of the contents of the code attempting the access.

In an operation 608, if the determination is made that the code attempting to access the LDR 406 should be able to do so (in operation 606), the invalid memory address used to access LDR within the thread context may be patched with the correct memory address. For example, the exception handler may edit the thread context to update the register referencing the invalid memory address 502 previously stored in the PEB 404 in place of the pointer to the LDR 406, and may update it with the correct memory address. Patching the memory within the thread context as described herein is distinguished from changing the address within the memory. Changing the address within the memory may be undesirable due to the possibility of allowing other threads unmitigated access and compromising the effectiveness of the systems and methods described herein. Therefore, the authorized code may be able to use the correct memory address in the PEB 404's link to the LDR 406 to access the LDR 406.

In an operation 610, it may be determined that the authorized access is complete, after which the exception handler may again be invoked to revert the patches register to the invalid memory address 502 again, to prevent the valid pointer to LDR 406 from being leaked to subsequent code. For example, unpatching the memory access may prevent a “good” section of code unlocking a memory access to flow through to a “bad” section of code that may then abuse the patched access. This operation may thus improve efficacy and effectiveness of the computing and MEDR systems and methods described herein.

In an operation 612, responsive to the determination (in operation 606) that memory access attempt to LDR is not from authorized code, the MEDR may be notified and mitigation of the unauthorized code attempting to access the memory may be triggered.

In various examples, the method 600 may be performed by one or more modules included in and executing on the endpoint 202. Examples of the MEDR described herein may include the one or more modules that monitor the endpoint 202 in the background, and inject one or more modules for performing the method 600 into some or any new programs starting execution on the endpoint 202, for example, shellcode programs. As part of the MEDR, when unauthorized access to the LDR 406 is attempted, relevant events may be logged and alerts may be raised, for example, as previously discussed with reference to FIGS. 1 and 2.

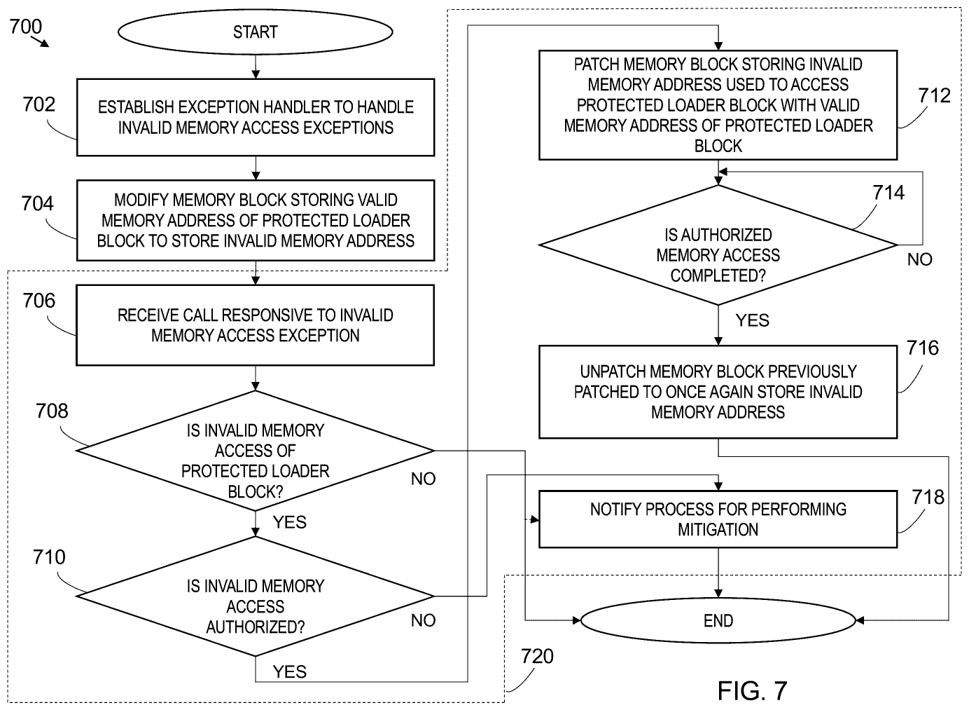

FIG. 7 illustrates an exemplary method 700 of guarding executable code's access to a loader block 406 associated with a process environment block 404. The process environment block 404 may be associated with a thread environment block 402. The exemplary method 700 may be performed by one or more hardware computing processors, for example, as illustrated and described herein with reference to FIG. 8.

In an operation 702, an exception handler may be configured and established to handle invalid memory access exceptions. Invalid memory access exceptions may include or be designated as/with memory access violations. With an exception handler in place to handle the invalid memory access exceptions, monitoring memory access attempts may be performed passively without consuming central processor unit (CPU) utilization. For example, an operating system of the computing system may notify the MEDR system when an invalid memory access exception occurs. In prior systems, in the absence of the use of an exception handler to handle invalid memory access exceptions, monitoring memory access may include utilizing guard pages, which may be unsuccessful. In contrast, utilizing an exception handler to handle invalid memory access exceptions as discussed herein, a thread context may be used to patch the memory access.

In an operation 704, a memory block storing a valid memory address of a protected loader block may be modified to store an invalid memory address, instead. For example, an LDR Guard Module may modify the memory address of the LDR 406 stored in the PEB 404 to point to an invalid memory address 502. In an example, program code (unauthorized or authorized) may dereference this pointer to access the protected memory of the loader block (e.g., LDR 406), either for read or write access. Operation 704 may only be performed once, and not repeatedly, in the method 700, due to the transient nature of the thread context of the method 700 described herein.

In an operation 706, the exception handler established in operation 702 may receive a call and/or be called in response to an invalid memory access exception. For example, the MEDR system may wait for an invalid memory access exception to be delivered to the exception handler configured and established in operation 702. In an example, memory access attempts to the invalid memory address that replaced the reference to LDR 406 may be monitored by an exception handler that responds to exception code 0xC0000005 (EXCEPTION_ACCESS_VIOLATION).

In an operation 708, a determination may be made regarding whether the invalid memory access exception of operation 706 was caused by an attempt to access an invalid memory address of a protected loader block (e.g., LDR 406) to access the protected loader block. If the invalid memory access exception was not caused by an attempt to access an invalid memory address of a protected loader block to access the protected loader block, either the processing of the exception handler may end, or an operation 718 to notify a process for performing mitigation may be performed.

If in operation 708, a determination is made that the invalid memory access exception was caused by an attempt to access an invalid memory address of a protected loader block to access the protected loader block, then processing of the exception handler may continue in an operation 710.

In operation 710, a determination may be made regarding whether the attempt to access the protected loader block via the attempt to access the invalid memory address is and/or should be authorized. If the attempt to access the protected loader block is and/or should not be authorized, the operation 718 to notify a process for performing mitigation may then be performed.

The attempt to access the protected loader block via the attempt to access the invalid memory address may be determined to be authorized if executable code attempting the access is an operating system code (e.g., a system DLL, NTDLL, etc.) or other authorized code. The attempt to access the protected loader block may be determined to be authorized if, for example, the attempted access is by a mapped module. In some examples, the attempt to access the protected loader block may be determined to be authorized according to a predetermined cybersecurity policy. In some examples, the attempt to access the protected loader block may be determined to be authorized based on an analysis of the contents of the code attempting the access.

If in operation 710, a determination is made that the attempt to access the protected loader block via the attempt to access the invalid memory address is and/or should be authorized, then processing of the exception handler may continue in an operation 712.

In operation 712, a memory block storing the invalid memory address of the protected loader block may be patched with a valid memory address of the protected loader block. The patched memory block may be disposed within a region of memory associated with a particular process environment block, that is also associated with the attempt to access the protected loader block. The particular process environment block may be associated with a thread environment block that is also associated with the attempt to access the protected loader block. The patching of the memory block storing the invalid memory address of the protected loader block may be performed within a thread context associated with the thread environment block. The patching of the memory block storing the invalid memory address of the protected loader block may be performed within a thread context associated with the attempt to access the protected loader block. The patching of the memory block storing the invalid memory address of the protected loader block may include editing the thread context to update a register referencing the invalid memory address with the valid memory address of the protected loader block.

For example, the exception handler may edit the thread context to update the register referencing the invalid memory address 502 previously stored in the PEB 404 in place of the pointer to the LDR 406, and may update it with the correct memory address. Patching the memory within the thread context as described herein is distinguished from changing the address within the memory. Changing the address within the memory may be undesirable due to the possibility of allowing other threads unmitigated access and compromising the effectiveness of the systems and methods described herein. Therefore, the authorized code may be able to use the correct memory address in the PEB 404's link to the LDR 406 to access the LDR 406.

In an operation 714, after the memory block is patched in operation 712, the processing of method 700 may wait until the authorized memory access that is enabled by patching the memory block in operation 712 is completed before moving forward to an operation 716. The waiting may be in the form of a loop that repeatedly checks whether the authorized memory access is completed, or checks for a notification or other indication that the authorized memory access is completed, before execution of the method 700 moves forward to the operation 716, for example.

In operation 716, the memory block that was previously patched in operation 712 may be unpatched to once again store an invalid memory address instead of a valid memory address of the protected loader block. The unpatching of the memory block may cause the memory block to once again store the same invalid memory address as was previously stored in the memory block prior to patching. The unpatching of the memory block may cause the memory block to store a different invalid memory address than was previously stored in the memory block prior to patching. The unpatching of the memory block may be performed within a thread context associated with the attempt to access the protected loader block. The unpatching of the memory block may include editing the thread context to update a register referencing the memory address of the protected loader block. The unpatching of the memory block may be performed to prevent the valid pointer to LDR 406 from being leaked to subsequent code. For example, unpatching the memory block may prevent a “good” section of code unlocking a memory access to flow through to a “bad” section of code that may then abuse the patched access. This operation may thus improve efficacy and effectiveness of the computing and MEDR systems and methods described herein. After completion of operation 716, the method 700 may end.

In operation 718, which may be called by operation 708 and/or 710 as described above, a process for performing mitigation after determining that an invalid memory access was attempted which was not authorized may be notified and/or called to perform the mitigation. For example, the MEDR may be notified to perform the mitigation of the unauthorized code attempting to access the memory. The mitigation to be performed may include logging relevant events associated with the attempted invalid memory access, for example, in one or more computing logs 110. The logging may include identifying portion(s) of the computing system that have been compromised or attempted to be compromised by a cyberattack responsible for the attempted invalid memory access. The logging may include identifying one or more login accounts associated with a cyberattack responsible for the attempted invalid memory access. The mitigation to be performed may include raising one or more alerts to provide notification of the attempted invalid memory access. The mitigation to be performed may include disabling compromised portion(s) of the computing system and/or one or more login accounts associated with a cyberattack responsible for the attempted invalid memory access. After operation 718 is completed, the method 700 may end.

Operations 706, 708, 710, 712, 714, 718, and 718, as described above, may all be included in and/or performed by an exception handler 720, for example, as established in operation 702 described above. The exception handler 720 may be called whenever an invalid memory access exception is raised in a computing system configured to perform the method 700.

In various examples, the method 700 may be performed by one or more modules included in and executing on the endpoint 202. Examples of the MEDR described herein may include the one or more modules that monitor the endpoint 202 in the background, and inject one or more modules for performing the method 700 into some or any new programs starting execution on the endpoint 202, for example, shellcode programs. As part of the MEDR, when unauthorized access to the LDR 406 is attempted, relevant events may be logged and alerts may be raised, for example, as previously discussed with reference to FIGS. 1 and 2.

Examples of the MEDR described herein may improve the performance of computing systems and improve security of the computing systems against cybersecurity threats, compared to prior systems. Some aspects of the MEDR described herein include deterministic behavior and performance, improving identification and response when detecting malicious code. Security strength of the examples of the MEDR described herein may not be dependent upon hashing algorithms that may be utilized, in contrast to prior systems. In the exemplary MEDR systems described herein, unauthorized attempts to access the LDR may be blocked before any hashing takes place, in contrast to prior systems.

FIG. 8 depicts a block diagram of an example computer system 800 in which examples described herein may be implemented. The computer system 800 may include a bus 802 or other electronic communication mechanism for communicating information, and one or more hardware processors 804 coupled with the bus 802 for processing information. The hardware processor(s) 804 may include, for example, one or more general purpose microprocessors and/or application specific integrated circuits (ASICs) configured to perform the processes and methods described herein and related processes and methods.

The computer system 800 also may include a main memory 806, for example, a random access memory (RAM), cache, and/or other dynamic storage devices, coupled to the bus 802 for storing information and instructions to be executed by the processor(s) 804. The main memory 806 also may be used for storing temporary variables or other intermediate information during execution of instructions to be executed by the processor(s) 804. Such instructions, when stored in storage media accessible to the processor(s) 804, may render computer system 800 into a special-purpose machine that is customized to perform the operations specified in the instructions.

The computer system 800 may further include a read only memory (ROM) 808 and/or other static storage device coupled to the bus 802 for storing static information and instructions for the processor(s) 804. A storage device 810, for example, a magnetic disk, optical disk, and/or USB thumb drive (Flash drive), etc., may be provided and coupled to the bus 802 for storing information and instructions.

The computer system 800 may be coupled via the bus 802 to a display 812, for example, a liquid crystal display (LCD), light emitting diode (LED) display, touch screen, and/or other electronic display for displaying information to a computer user. One or more input device(s) 814, including alphanumeric and/or other keys, may be coupled to the bus 802 for communicating information and command selections to the processor(s) 804. Another type of user input device may include cursor control 816, for example, a mouse, a trackball, a touchpad, and/or a set of cursor direction keys for communicating direction information and command selections to the processor(s) 804 and for controlling cursor movement on the display 812. In some examples, direction information and command selections as may be provided by cursor control may also or alternatively be implemented via receiving touches on a touch screen without the use of a separate cursor control device.

The computing system 800 may include a user interface module to implement a graphical user interface (GUI) that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the words “component,” “engine,” “system,” “database,” “data store,” and the like, as used herein, may refer to logic embodied in hardware or firmware, or to a collection of software instructions, possibly having entry and exit points, written in a programming language, such as, for example, Java, C, or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, and/or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 may cause the processor(s) 804 to perform the process steps and/or operations described herein. In alternative embodiments, hard-wired circuitry may be used in place of or in combination with software instructions.

The term “non-transitory media,” and similar terms, as used herein refers to any non-transitory media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media may also take the form of acoustic or light waves, such as those generated during radio-wave and infra-red data communications.

The computer system 800 may also include one or more communication network interface(s) 818 coupled to the bus 802. The network interface(s) 818 may provide two-way data communication coupling to one or more network links that are connected to one or more local networks. For example, the network interface(s) 818 may include an integrated services digital network (ISDN) card, cable modem, satellite modem, or a modem to provide a data communication connection to a corresponding type of telephone line. As another example, the network interface(s) 818 may include a local area network (LAN) card to provide a data communication connection to a compatible LAN (and/or a wide area network (WAN) component to communicate with a WAN). Wireless links may also be implemented. In any such implementation, the network interface(s) 818 send and receive electrical, electromagnetic, and/or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP in turn may provide data communication services through the worldwide packet data communication network now commonly referred to as the “Internet.” Local network and Internet both use electrical, electromagnetic, and/or optical signals that carry digital data streams. The signals through the various networks and the signals on network link and through network interface(s) 818, which may carry the digital data to and from the computer system 800, are example forms of transmission media.

The computer system 800 may send messages and receive data, including program code, through the network(s), network link and network interface(s) 818. In the Internet example, a server might transmit a requested code for an application program through the Internet, the ISP, the local network, and the network interface(s) 818.

The received code may be executed by the processor(s) 804 as it is received, and/or stored in the storage 810, or other non-volatile storage for later execution.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. One or more non-transitory machine-readable media storing instructions which, when executed by one or more processors, cause:
establishing an exception handler configured to be called responsive to the one or more processors detecting an invalid memory access exception, the exception handler configured to perform at least the following processes:
determining whether the invalid memory access exception was caused by an attempt to access an invalid memory address of a protected loader block to access the protected loader block;
responsive to a determination that the invalid memory access exception was caused by an attempt to access an invalid memory address of a protected loader block, determining whether the attempt to access the protected loader block should be authorized;
responsive to a determination that the attempt to access the protected loader block should be authorized, performing:
patching a memory block storing the invalid memory address of the protected loader block with a valid memory address of the protected loader block;
determining whether the authorized attempt to access the protected loader block has been completed; and
responsive to a determination that the authorized attempt to access the protected loader block has been completed, unpatching the memory block previously patched with the valid memory address of the protected loader block to store the invalid memory address again; and
responsive to a determination that the attempt to access the protected loader block should not be authorized, performing:
notifying a process for performing mitigation of the unauthorized attempt to access the protected loader block;
modifying the memory block storing the valid memory address of the protected loader block to store the invalid memory address;
receiving, by the exception handler, a call responsive to an invalid memory access exception; and
responsive to the received call by the exception handler, performing the processes of the exception handler.

2. The media of claim 1, wherein the memory block storing the valid memory address of the protected loader block is disposed within a region of memory that is associated with a particular process environment block associated with the attempt to access the protected loader block.

3. The media of claim 2, wherein the particular process environment block is associated with a thread environment block associated with the attempt to access the protected loader block.

4. The media of claim 3, wherein patching the memory block storing the invalid memory address of the protected loader block with the valid memory address of the protected loader block is performed within a thread context associated with the thread environment block and with the attempt to access the protected loader block.

5. The media of claim 4, wherein patching the memory block storing the invalid memory address of the protected loader block with the valid memory address of the protected loader block comprises editing the thread context to update a register referencing the invalid memory address with the valid memory address of the protected loader block.

6. The media of claim 1, further storing instructions which, when executed by one or more processors, cause logging one or more events and/or raising one or more alerts responsive to the determination that the attempt to access the protected loader block should not be authorized.

7. The media of claim 1, wherein the determination that the attempt to access the protected loader block should be authorized may be made responsive to a determination that the attempt is being made by operating system code.

8. The media of claim 1, wherein the determination that the attempt to access the protected loader block should be authorized may be made responsive to a determination that the attempt is being made by an authorized program code.

9. The media of claim 1, wherein the determination that the attempt to access the protected loader block should be authorized may be made responsive to a determination that the attempt is being made by a mapped module.

10. The media of claim 1, wherein the determination that the attempt to access the protected loader block should be authorized may be made responsive to a predetermined cybersecurity policy.

11. The media of claim 1, wherein the determination that the attempt to access the protected loader block should be authorized may be made based on an analysis of contents of code attempting to access the protected loader block.

12. A system for guarding module loading for cybersecurity of a computing system, the system comprising:
a hardware computing processor;
a non-transitory memory having stored thereon computing instructions, executable by the hardware computing processor, to perform operations of a method for guarding module loading for cybersecurity of a computing system, the method comprising:
establishing an exception handler configured to handle an invalid memory access exception;
modifying a memory block storing a valid memory address of a protected loader block to store an invalid memory address;
receiving, by the exception handler, a call responsive to the invalid memory access exception;
responsive to the received call by the exception handler, determining whether the invalid memory access exception was caused by an attempt to access an invalid memory address of a protected loader block to access the protected loader block;
responsive to a determination that the invalid memory access exception was caused by an attempt to access an invalid memory address of a protected loader block, determining whether the attempt to access the protected loader block should be authorized;
responsive to a determination that the attempt to access the protected loader block should be authorized, performing:
patching a memory block storing the invalid memory address of the protected loader block with a valid memory address of the protected loader block;
determining whether the authorized attempt to access the protected loader block has been completed; and
responsive to a determination that the authorized attempt to access the protected loader block has been completed, unpatching the memory block previously patched with the valid memory address of the protected loader block to store the invalid memory address again; and
responsive to a determination that the attempt to access the protected loader block should not be authorized, performing:
notifying a process for performing mitigation of the unauthorized attempt to access the protected loader block.

13. The system of claim 12, wherein the memory block storing the valid memory address of the protected loader block is disposed within a region of memory that is associated with a particular process environment block associated with the attempt to access the protected loader block.

14. The system of claim 13, wherein the particular process environment block is associated with a thread environment block associated with the attempt to access the protected loader block.

15. The system of claim 14, wherein patching the memory block storing the invalid memory address of the protected loader block with the valid memory address of the protected loader block is performed within a thread context associated with the thread environment block and with the attempt to access the protected loader block.

16. The system of claim 15, wherein patching the memory block storing the invalid memory address of the protected loader block with the valid memory address of the protected loader block comprises editing the thread context to update a register referencing the invalid memory address with the valid memory address of the protected loader block.

17. The system of claim 12, wherein the non-transitory memory further stores instructions which, when executed by the processor, cause logging one or more events and/or raising one or more alerts responsive to the determination that the attempt to access the protected loader block should not be authorized.

18. The system of claim 12, wherein the determination that the attempt to access the protected loader block should be authorized is made responsive to a determination that the attempt is being made by operating system code.

19. The system of claim 12, wherein the determination that the attempt to access the protected loader block should be authorized is made responsive to a determination that the attempt is being made by an authorized program code.

20. A method comprising:
establishing an exception handler configured to handle an invalid memory access exception;
modifying a memory block storing a valid memory address of a protected loader block to store an invalid memory address;
receiving, by the exception handler, a call responsive to the invalid memory access exception;
responsive to the received call by the exception handler, determining whether the invalid memory access exception was caused by an attempt to access an invalid memory address of a protected loader block to access the protected loader block;
responsive to a determination that the invalid memory access exception was caused by an attempt to access an invalid memory address of a protected loader block, determining whether the attempt to access the protected loader block should be authorized;
responsive to a determination that the attempt to access the protected loader block should be authorized, performing:
patching a memory block storing the invalid memory address of the protected loader block with a valid memory address of the protected loader block, the patched memory block disposed within a region of memory associated with a particular process environment block associated with the attempt to access the protected loader block, the particular process environment block associated with a thread environment block also associated with the attempt to access the protected loader block, the patching performed within a thread context associated with the thread environment block and with the attempt to access the protected loader block, and the patching comprising editing the thread context to update a register referencing the invalid memory address with the valid memory address of the protected loader block;
determining whether the authorized attempt to access the protected loader block has been completed; and
responsive to a determination that the authorized attempt to access the protected loader block has been completed, unpatching the memory block previously patched with the valid memory address of the protected loader block to store the invalid memory address again; and
responsive to a determination that the attempt to access the protected loader block should not be authorized, performing:
notifying a process for performing mitigation of the unauthorized attempt to access the protected loader block.
